(19) United States
(12) Patent Application Publication
(10) Pub. No.: US 2013/0308319 A1
(43) Pub. Date: Nov. 21, 2013

(54) LED LAMP

(71) Applicants: WAN-JIONG LIN, (US); SELF ELECTRONICS USA CORPORATION, Norcross, GA (US); NINGBO SELF ELECTRONICS CO., LTD., Ningbo (CN)

(72) Inventors: Fa-Wei Zhang, Ningbo (CN); Tao-Lin Zhu, Ningbo (CN); Zhao-Yong Zheng, Ningbo (CN); Wan-Jiong Lin, Ningbo (CN)

(73) Assignees: NINGBO SELF ELECTRONICS CO., LTD., Ningbo (CN); SELF ELECTRONICS USA CORPORATION, Norcross, GA (US)

(21) Appl. No.: 13/988,132

(22) PCT Filed: Dec. 23, 2010
(86) PCT No.: PCT/CN10/02138

§ 371 Date: Jun. 10, 2013

(30) Foreign Application Priority Data
Nov. 19, 2010 (CN) 201010565948.3

(51) Int. Cl. F21V 1/00; F21V 5/00

(52) U.S. Cl. CPC F21V 1/00; F21V 5/00
USPC 362/311.01

(57) ABSTRACT

An LED lamp includes a lens which forms a light emitting surface and a shade mounted on the light emitting surface. Each of the shades includes a hole whose sectional area in radial direction is equal to that of the light emitting surface, an axial height of the hole following the formula of

$${H}_{ϕ} = \frac{{φ }_{max}}{tan {θ}_{max}} ,$$

wherein H_{φ} is the axial height of the hole, φₘₐₓ is a diameter value of the light emitting surface, and θₘₐₓ is an output angle of the lens. Accordingly, a work area of the LED lamp can be extended since the shade shields the stray light of a glare area of the LED lamp and strictly separates the work area from the glare area, and no stray light escapes. Therefore, the LED lamp can achieve light distribution as designed without glare under cooperation of the lens and the shade.

### CROSS REFERENCE TO RELATED APPLICATION

This application is a national phase application of and claims the benefits of PCT Application No. PCT/CN/2010/002138, filed on Dec. 23, 2010.

### BACKGROUND

1. Technical Field

The disclosure relates to electrical lighting devices, and more particularly to an LED lamp using at least one single-chip or multi-chip light-emitting-diode (“LED”), and a shade module which minimizing glare.

2. Description of the Related Art

For years, people have used traditional incandescent or fluorescence lighting apparatus in order to address their interior lighting concerns. However, such lighting apparatus presents a number of drawbacks. For example, the popular halogen apparatus presents the following drawbacks, such as relatively high power consumption, inefficiency of light dispersion due to the placement of its metal shield in the line sight of the halogen bulb, and its limited effectiveness in preventing glare from the halogen bulb.

Recently, a number of LED lighting apparatuses have been designed to replace the halogen apparatus, as well as other traditional incandescent or fluorescence lighting apparatuses. Typically, in such LED lighting apparatuses, the LED light source is located at the center of a reflector with its light emission directed outward from the reflector. Additional, there are LED lighting apparatuses which use multiple LEDs with their light emissions directed outward from one or more reflectors. These configurations are unable to achieve narrow beam angles, and result in considerable glare since observers are not shielded from the LED light source. Further, these configurations inefficiently distribute heat; thereby, making the use of high-powered LEDs in these configurations practically prohibitive.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric configuration view of an anti-glare LED spotlight in accordance with one embodiment of the disclosure (plan view).

FIG. 2 is an isometric section view of the anti-glare LED spotlight of FIG. 1 (no cover).

FIG. 3 is an isometric explored view of the embodiment.

FIG. 4 is a configuration view of a ring of the embodiment.

FIG. 5 is a partial enlarged view of the ring of FIG. 4 in I.

FIG. 6 is a section view of the embodiment.

FIG. 7 is a second isometric view of the anti-glare LED spotlight of FIG. 1 (rear view).

FIG. 8 is a first isometric view of an anti-glare module of the embodiment.

FIG. 9 is a second isometric view of the anti-glare module of the embodiment.

FIG. 10 is an isometric view of a lens module of the embodiment.

FIG. 11 is an isometric view of a house of the embodiment.

FIG. 12 is a light path view of the embodiment.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

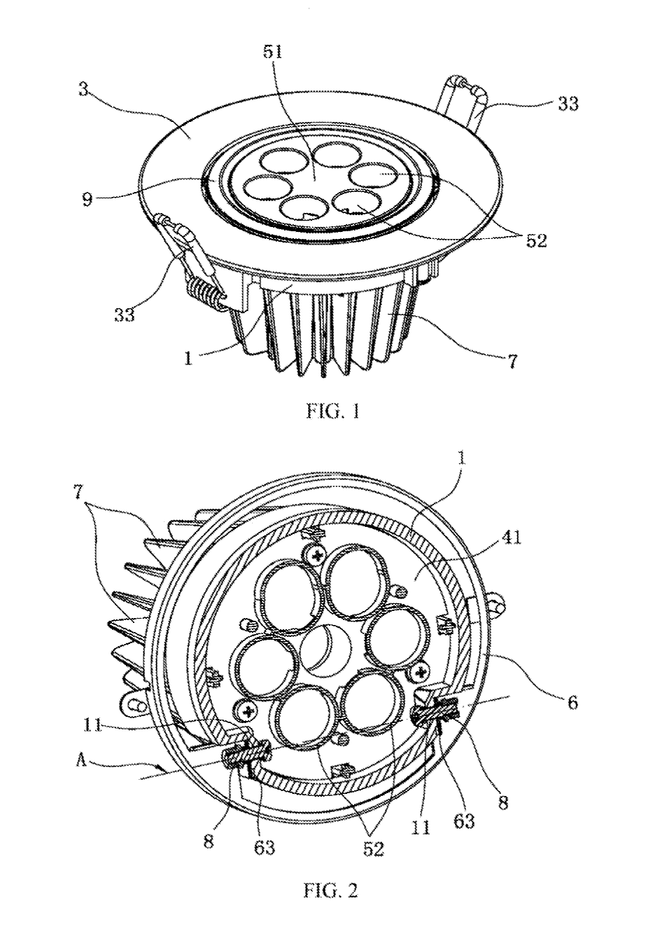

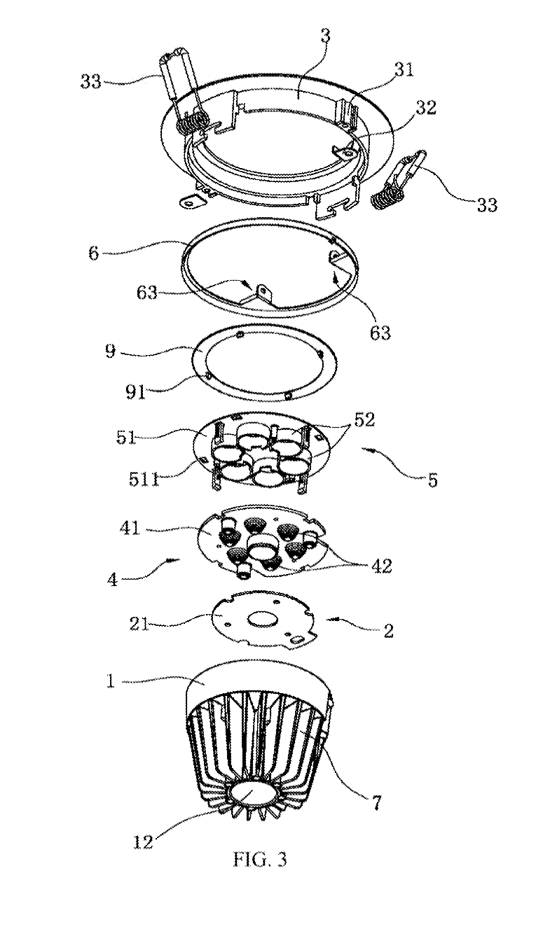

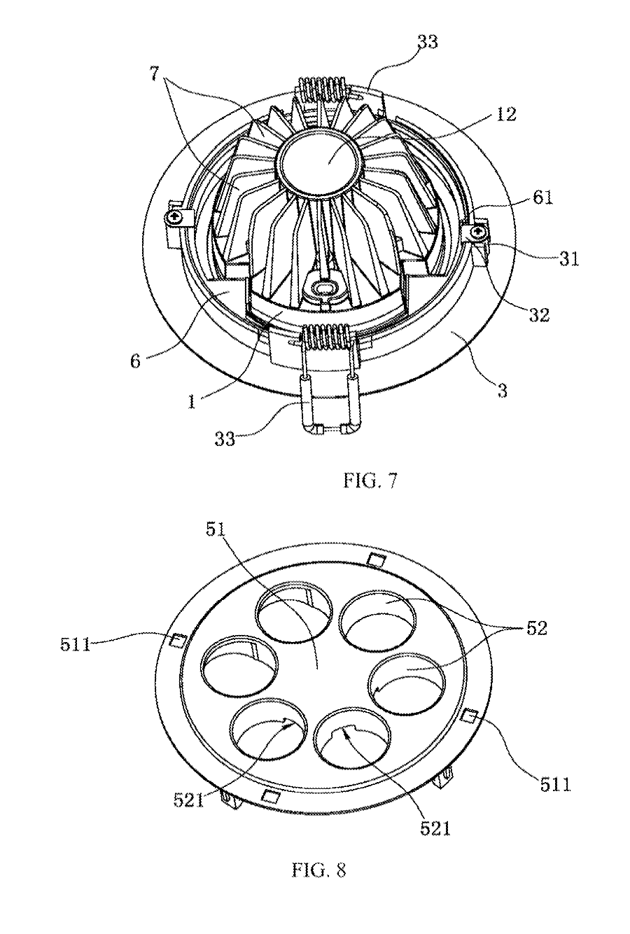

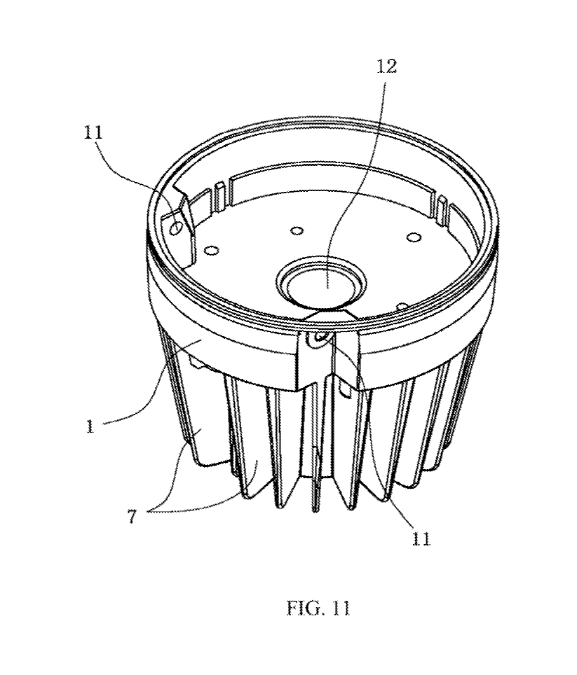

Referring to FIGS. 1-12, a LED lamp according to an embodiment is shown. The LED lamp includes a house 1, a light module 2 mounted in the house 1, at least a lens module 4 disposed in the house 1 along an optical axis of the light module 2, a shade module 5 arranged in the lens module 4, a light frame 3 mounted in an end of the house 1, and a ring 9 surrounding the house 1.

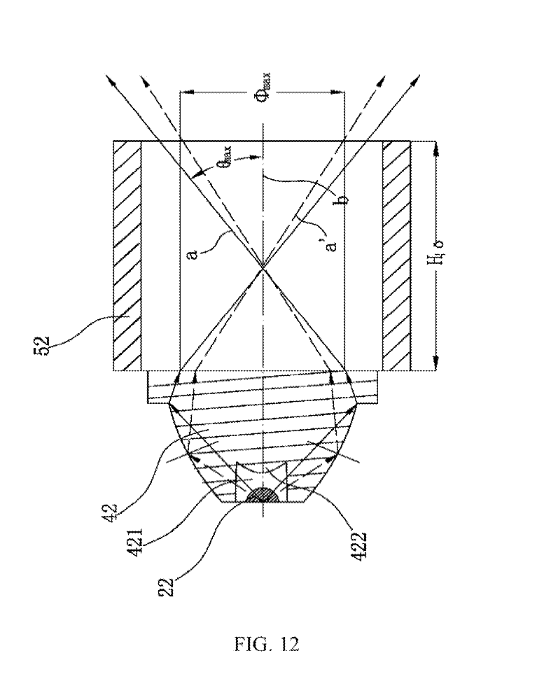

Referring to FIG. 11 together with FIG. 1, the house 1 has a cup-shaped structure and includes a number of heat sinks 7 around outer surface thereof, a first through hole 12 opened along an circumference axis thereof, a place for mounting the light module 2, and two first pin holes 11 being respectively opened in two side walls thereof. The house 1 may be manufactured via extrusion molding process and may be formed of aluminum, aluminum alloy, and so on. In the present embodiment, the house 1 is made of aluminum alloy for light-weight. The heat sinks 7 extend from the outer surface of the body of the house 1 against a center of the house 1 and are integratedly manufactured with a body of the house 1. The first through hole 12 is opened along a central circumference axis of the house 1 and passes through the body of the house 1 for effectively dissipating heat. The two first pin holes 11 are eccentrically arranged with a center of the house 1. More detailed explanation about the two first pin holes 11 will be described later.

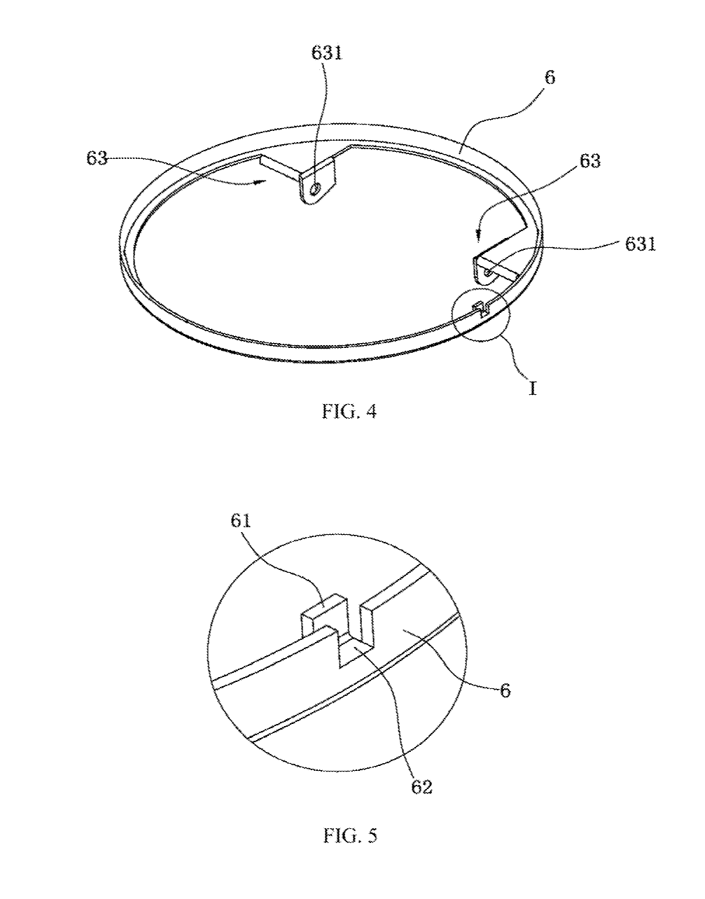

Referring to FIG. 3 and FIG. 6 together with FIG. 1, the light module 2 includes a printed circuit board (PCB) 21, and a number of LEDs 22 mounted on the PCB 21. Understandably, the light module 2 further includes other electronic components, such as capacitor, inductor, diode, transistor, and so on. For a person skilled in the art, the electronic components are well known. The PCB 21 is installed on the place of the house 1 via some fasteners, such as screws, or pin, thereby fixing the light module 2 in the house 1. The LEDs 22 are well known for a person skilled in the art and are not described in detail. In the embodiment, the LED lamp has 6 LEDs 22. The light module 2 further includes a second through hole 211 which opened along the central circumference axis of the house 1 and used for connecting with the first through hole 12. The LEDs 22 of the 6 light module are arranged on the PCB 21 in such a manner that the 6 LEDs surround the second through hole 211 with a substantially regular interval.

The lens module 4 includes a lens base 41, a number of lenses 42 disposed on the lens base 41, and a third through hole 411 opened in the lens base 41 along the central circumference axis of the house 1. The lens base 41 is configured for assembling the lens module 4 into the house 1 via some fasteners, for example, screws and so on. The lens base 41 is integratedly manufactured with the lens 42 via extrusion mold process. The lenses 42 are light distribution lenses and are used for emitting forward light of the LEDs 22 disposed in the center thereof. Each of the lenses 42 includes a light emitting surface with a circular shape in plan view and is made of a transparent acrylic material and the like and is formed like a mortar of conic shape of which circular portion is formed upward. There is a diameter value for the light emitting surface to determine beam widths thereof. A maximum diameter of the light emitting surface 321 is represented with the reference numeral φₘₐₓ. In the section view of the lenses 42, an output angle between light path of light emitted from the outermost boundary of the light emitting surface and the optical axis thereof is represented with the reference numeral θₘₐₓ. In other words, the output angle is a maximum angle in all of angle between the light paths and the optical axis. Each of the lenses 42 further includes an LED recess 421 provided so as to efficiently emit the light from the LEDs 22 at the center thereof. According to the embodiment of the present disclosure, the lens module 30 has 6 lenses 42 in corresponding with the 6 LEDs 22. The third through hole 411 has a section area along radial direction as same as that of the first through hole 12 and the second through hole 211. Understandably, the six lenses 42 are arranged on the lens base 41 in such a manner that the six lenses 42 surrounded the third through hole 411 with a substantially regular interval.

The shade module 5 includes a shade base 51 and a shade 52 formed in integrated with the shade base 51. The shade module 5 is made of a plastic material and the like. The shade base 51 is designed for assembling the shade module 5 into the house 1 and supporting the shade 52. The shade 52 is mounted on the emitting forward of the light emitting surface and includes a hole whose sectional area in radial direction is equal to that of the light emitting surface. In order to obstruct glare of the light module 2, an axial height H_{φ} of the hole 52 must follow the below formula:

$${H}_{ϕ} = \frac{{φ }_{max}}{tan {θ}_{max}} ,$$

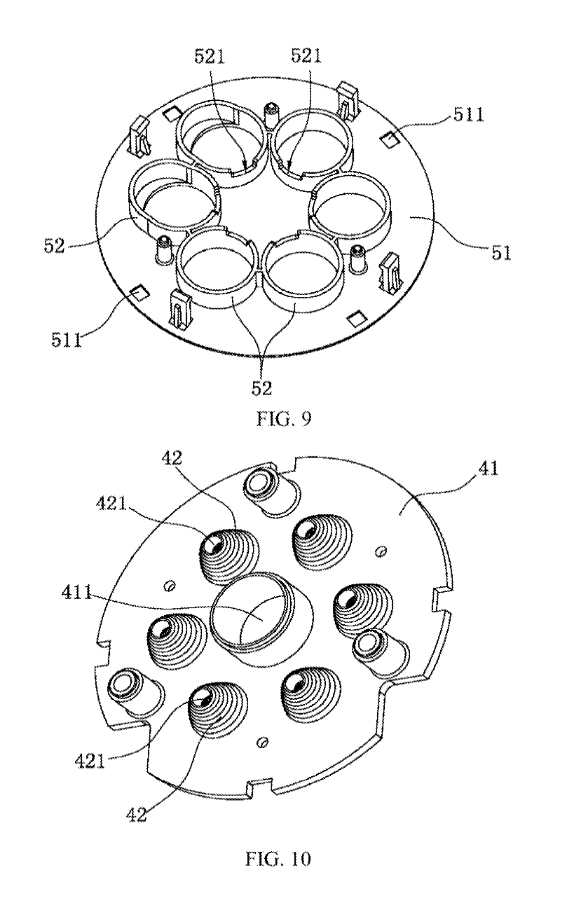

as shown in FIG. 12. The hole may be formed like some different section shape, such as circle, elliptic, polygon, and so on. When the hole of the shade 52 has the circle shape, a radius value of the circle shape equals to the maximum radial of the light emitting surface of the lenses 42. When the hole of the shade 52 has the elliptic shape, a minor axis of the elliptic shape has a length of equal to the maximum radial of the light emitting surface of the lenses 42. When the hole of the shade 52 has the polygon shape, a radial value of incircle of the polygon shape is equal to the maximum radial of the light emitting surface of the lenses 42. In the present embodiment, the hole is formed in circle shape, the diameter thereof is equal to the maximum diameter of the light emitting surface, thereby shielding glare emitted from the LEDs 22. As shown in FIG. 9, the hole further includes at least an open 521 disposed at the end thereof for building an air passage between the open 521 and the first, second, and third through hole 12, 211, and 411 so as to improve heat dissipation, thereby elongating the lift-span of the LED lamp.

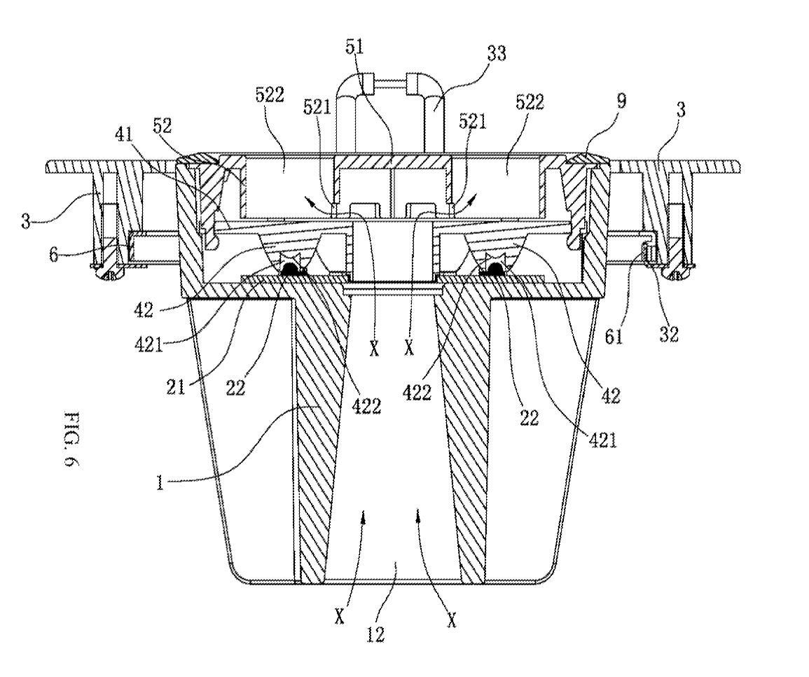

In order to extend the effective illuminated area of the LED lamp, it provides the ring 6 for finishing this job. The ring 6 is sheathed with the outer side of an end of the house 1, therefore, has an inner diameter as same as external diameter of the end of the house 1. Referring to FIG. 4, and FIG. 5, the ring 6 includes two arms 63 extending toward a center thereof from side wall thereof and two second pin holes 631 respectively opened in the two arms 63. The two second pin holes 631 are eccentrically arranged with a center of the ring 6 in correspondence with the first pin holes 11. The ring 6 further includes a stopper 61 which extends towards a center thereof. More detailed explanation relating to the limit part 91 will be given later.

Referring to FIG. 1 again, the LED lamp further includes a shaft 8 respectively mounted in the first pin holes 11 and the second pin holes 6 and configured for joining the house 1 with the ring 6. Since the first pin holes 11 and the second pin holes 63 are respectively and eccentrically disposed in the house 1 and the ring 6, the house 1 can rotate around the shaft 8 so as to change a radiation angle of the LED lamp over a wide range.

The light frame 3 includes a body, at least two ears 31 arranged in the body with regular interval, two elastic clips 33 disposed in the body, and at least two blocks 32 corresponding with the at least two ear 31. The body has a T-shaped section structure and includes an inner horizontal side, an outer horizontal side, and a perpendicular side. The inner horizontal side is used for clipping the ring 6 with the at least block 32 so as to fix the house 1. The outer horizontal side is used for assembling the LED lamp onto a ceiling with the two elastic clips 32. The at least two ears 31 are disposed on the perpendicular side and are opened a screwed hole for amounting the block 32 via screws. According to the present embodiment, the light frame 3 has two ears 31 and two blocks. The light frame 3 further includes a limit part 32 perpendicularly extending from the perpendicular side toward the center thereof. When the house 1 together with the ring 6 rotated around the circumference axis thereof, the limit part 32 is used to block against the stopper 61 of the ring 6 so as to determine a rotating angle of the house 1 which less than 360 degree.

The shade module 5 of the anti-glare LED spotlight is connected with an end cap 9 like annular. The end cap 9 includes a plurality of clips 91 formed thereon. The shade base 51 of the shade module 5 includes a plurality of grooves 511 formed therein along the periphery thereof. The clips 91 insert into the grooves 511 to connect the end cap 9 to the shade module 5. The diameter of the end cap 9 is equal to that of open of the house 1 for just right receiving the end cap 9 into the open of the house 1.

Primarily, it needs to explain the generation principle of glare without the shade module 5. In a section of luminance area, it can be divided into three areas. One is glare area, second is work area, and others is dark area. The glare area means that when a person gets into the glare area, some stray light emitted from the LEDs 22 is seen or shot into eye even if the person does not stare at the LED lamp directly. Therefore, the stray light is not need and should be cancelled as far as possible. The work area means that when a person gets into the work area, bright light emitted from the LEDs 22 does not shot into eye due to the eyelid of the eye only when the person stares at the LED lamp directly. In other words, when the person looks at the front horizontally and looks at the feet, the bright light which may causes people discomfort does not get into eye therein. The dark area means that whether a person stares at the LED lamp or not, light emitted from the LEDs 22 does not shine on it always. Traditional lamps do not efficiently distinguish the work area and the glare area. As a result, the stray light of the glare area are not shielded in order to have larger plane of lamination. On the other hand, for completely shielding the stray light, the work area is reduced so that bright light, which laminates the work area, is obstructed. In the present embodiment of the disclosure, the stray light in the glare area will be shielded by the shade module 5 and does not glare into the eye whether the person stares at the LED lamp or not in contrast of the glare area of the traditional LED lamp. In case of following the formula of

$${H}_{ϕ} = \frac{{φ }_{max}}{tan {θ}_{max}} ,$$

the work area can be extend the most thereof since the shade module 5 shields the stray light of the glare area and strictly separates the work area from the glare area, and no stray light shot into eye in any areas. Accordingly, the LED lamp can achieve light distribution as designed without glare under cooperation of the lens module 2 and the shade module 5.

While the disclosure has been described by way of example and in terms of exemplary embodiment, it is to be understood that the disclosure is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

1-17. (canceled)

18. An LED lamp comprising:
a house;
a light module mounted in the house, the light module including a printed circuit board, and at least a LED chip electrically connected to the printed circuit board; and
a light frame disposed in front of the house;
a lens module received in the house and disposed in front of the light module, the lens module including a lens base, and lenses disposed on the transparent board, the lenses being response to the LED chip, and each of the LED chip being disposed on the bottom of the lenses;
an shade module received in the house and disposed in front of the lens module, the shade module including a shade base and an shade disposed on the shade base, the shade being responsive to the lenses, and a bottom of the shade touching the lens base.

19. The LED lamp of claim 18, wherein the lenses are formed like a mortar of conic shape, a big end of the lenses is connected to the lens base, and the big end work as a light emitting surface, a LED recess is opened in a small end of the lenses along the longitudinal direction, the LED chip is received in the LED recess.

20. The LED lamp of claim 19, wherein the shade has equal section area and the shape and area of the section of the hole is same as that of the light emitting surface of the lens, the best height of the hole must meet the following formula:
$${H}_{ϕ} = \frac{{φ }_{max}}{tan {θ}_{max}} ,$$
wherein φₘₐₓ is a maximum diameter of the light emitting surface, θₘₐₓ is an maximum output angle between light path of light emitted from the outermost boundary of the light emitting surface and the optical axis of the converging lens, when the hole of the shade may be formed like some different section shape, such as circle, elliptic, polygon, and so on, when the hole of the shade has the circle shape, a radius value of the circle shape equals to the maximum radial of the light emitting surface of the lenses, when the hole of the shade has the elliptic shape, a minor axis of the elliptic shape has a length of equal to the maximum radial of the light emitting surface of the lenses, when the hole of the shade has the polygon shape, a radial value of incircle of the polygon shape is equal to the maximum radial of the light emitting surface of the lenses.

21. The LED lamp of claim 20, wherein the LED lamp includes a ring, the ring is connected to the shade and rotates around the shade, the house further includes two first hinge holes opened on the periphery thereof, the two first hinge holes are symmetric with center axis of the house, connection between the two first hinge holes is eccentrically arranged with a center of the ring, the ring includes two connectors formed in an inner side thereof in response to the two first hinge holes respectively, each of the two connectors includes a second hinge hole open therein, a shaft crosses through the two first hinge holes and the two second hinge holes.

22. The LED lamp of claim 21, wherein a stopper extends towards a center of the ring and a limiting part perpendicularly extends from the perpendicular side toward the center of the shade.

23. The LED lamp of claim 22, wherein a section of the stopper likes L-shape, an open is formed in the stopper of the ring, the light frame further includes an arm extending toward the center thereof along the periphery thereof, and the limit part is located on the arm and has a reverse L-shape.

24. The LED lamp of claim 18, wherein the house further includes a heat sink integratedly formed therewith, a first through hole is opened in the house along center axis thereof, a second through hole is opened in the print circuit board along center axis of the house, a third through hole is opened in the lens base along the center axis of the house, at least one open is form on the bottom of each of the shade, the third through hole is connected to the each of the shade via the at least one open.

25. The LED lamp of claim 18, wherein the LED lamp includes an end cap, the end cap closes the bottom of the shade module, the diameter of the end cap is equal to that of open of the house.
